(19) United States
(12) Patent Application Publication
(10) Pub. No.: US 2006/0005685 A1
(43) Pub. Date: Jan. 12, 2006

(54) Transport apparatus for surface cutting equipment and method of use

(76) Inventor: Thomas Lynde, Harrisburg, SD (US)

Correspondence Address: Thomas Lynde, 27232 471 Ave., Harrisburg, SD, 57032, US

(21) Appl. No.: 10/887,445

(22) Filed: Jul. 9, 2004

(51) Int. Cl. B26D 1/00

(52) U.S. Cl. 83/651

(57) ABSTRACT

A secure transport means for surface cutting equipment that prevents damage to the equipment by lifting the surface cutting device off the floor so that it cannot roll into things and isolating the diverter assembly and blade of the surface cutting device with a durable shield. The transport frame can attach to the underside of the surface cutting device. Moreover the transport frame may be secured to the transport vehicle by anchoring devices. Facilities integrated into the structure of the frame allow the cutting device to be locked to the frame via the attaching means or a separate tethered lock.

### FIELD OF THE INVENTION

The present invention relates in general to apparatus and methods for safe and secure transport and storage of surface cutting equipment.

### BACKGROUND

Surface cutting equipment such as concrete saws and soft-cut saws are frequently transported from work project to work project in the payload sections of trailers trucks and vans. Although many such surface cutting equipment have methods of retracting the blade above the ground the blade frequently can be damaged when contacting other materials on the vehicles floor. One of the reasons why this happens is that current blade protection methods do not isolate the blade from materials rolling along the bed of a pickup, van or truck. Damage to other parts of the saw device can also be received when these sawing devices roll freely within the vehicle due to the fact that many of their wheels and/or rollers have no constraints. What is needed to avoid this problem and the potential for damage is a structure that would restrain the sawing device from moving freely while being transported. Furthermore this device should also protect the blade from the possibility of damage by isolating the blade from contact with foreign objects within the transport vehicle. In addition the structure should support the sawing device by parts of the saw's frame designed to carry the weight of the machine. The structure should include a method of securing the saw to the structure and a method of securing the structure to the vehicle. More over a method of accessing the blade of the saw while the saw was mounted to the structure would be beneficial.

### SUMMARY OF THE INVENTION

The present invention teaches an apparatus and method for transporting surface cutting devices in or on a vehicle wherein the cutting device is restrained from moving and possibly receiving damage do to contacting the vehicle or materials therein. The subject apparatus would include a base frame that would itself or through intermediary feet or anchoring devices contact the vehicle bed in a manner that would provide constraint from the inertial forces that can be experienced during transport. The base frame would include support posts to elevate the cutting device above the floor so that the cutting device's wheels, rollers and/or blade could not contact with the floor within the vehicle. The support structure would be designed to support the saw device on portions of the saw's framework easily able to bear the weight of the saw itself. The portion of the structure that contacts the saw device should conform to the support framework of the saw and provide for easy mounting and dismounting of the equipment from the structure. The base frame may include a shield to isolate the blade or portions of the blade of the saw from coming into contact with any object that may cause harm. This shield may make available access to the blade of the saw when the saw device was mounted on the structure. Means for securing the saw to the structure may be provided by catching members on one or more sides of the base frame. These securing devices may include locking devices or assemblies for using preexisting locking devices to secure the saw device to the structure. Means for fixedly or removably connecting the structure to the floor of the vehicle may be provided on the base frame. These anchoring devices may include locking means incorporated in their designs or be designed to accept additional locking means.

### DESCRIPTION OF THE DRAWINGS

FIG. 1 is a perspective view of a soft-cut saw situated above the invention in the position of mounting.

FIG. 2 is a perspective view of the present invention.

FIG. 3 is a top view of the present invention.

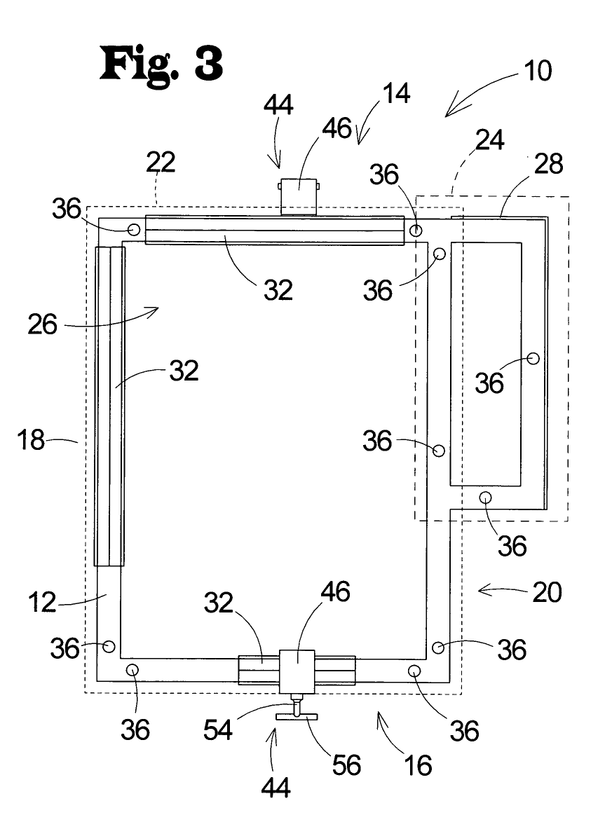

FIG. 4 is front view of the present invention demonstrating accessibility to the blade area via a hinged blade shield.

FIG. 5 is right side view of the present invention demonstrating the use of retractable wheels and anchoring device.

FIG. 6 is a cross section of a securing device of the present invention.

### DETAILED DESCRIPTION

In the following detailed description, reference is made to the accompanying drawings which form a part hereof, and in which is shown by way of illustration specific embodiments in which the invention may be practiced. These embodiments are described in detail sufficient to enable those skilled in the art to practice the invention, and it is to be understood that other embodiments may be utilized and that structural, logical and electrical changes may be made without departing from the spirit and scope of the present invention. The following detailed description is, therefore, not to be taken in a limiting sense, and the scope of the present invention is defined by the appended claims.

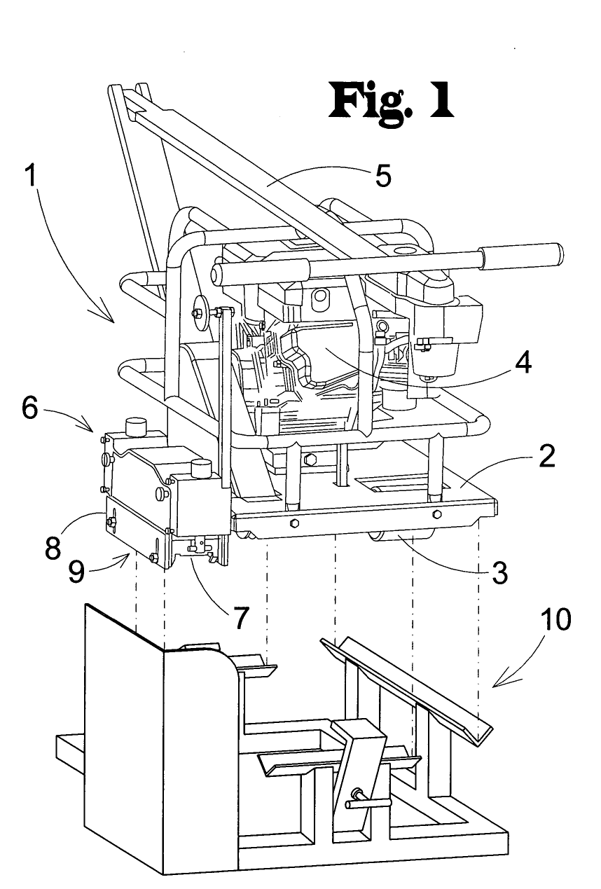

FIG. 1 shows an embodiment of the transport apparatus for surface cutting equipment (10) ready to receive a surface cutting device (1). In this depiction the surface cutting device (1) is an early entry concrete saw. The surface cutting device (1) is shown in storage or transport configuration with the operating yoke (5) folded down. The surface cutting device (1) includes a base plate (2) which protects the motor (4) from debris while cutting. The surface cutting device (1) includes variable height rollers (3) to elevate or lower the surface cutting device (1) so that the blade (9) may engage or disengage from the target media. The blade (9) is housed in the diverter assembly (6) which includes a front diverter (7) and rear diverter (8) which are necessary to achieve a finished cut. The blade (9), front diverter (7) and rear diverter (8) are relatively fragile and need to be protected while not in use. The surface cutting device (1) over all also may be damaged in transport if it is not immobilized and secured.

In FIG. 1 the embodiment of the transport apparatus for surface cutting equipment (10) conforms to the specifications of the surface cutting device's (1) design in that the cradles (32) are positioned respective to the edge of the base plate (2), the posts (30) are of sufficient length to elevate the rollers (3) and blade (9) off the floor, the blade shield (28) correspond to the relative dimensions in order to nest the diverter assembly (6) and the catch (46) is positioned above the cradle (32) in relation to the depth of the base plate (2) so that it may be secured without slippage.

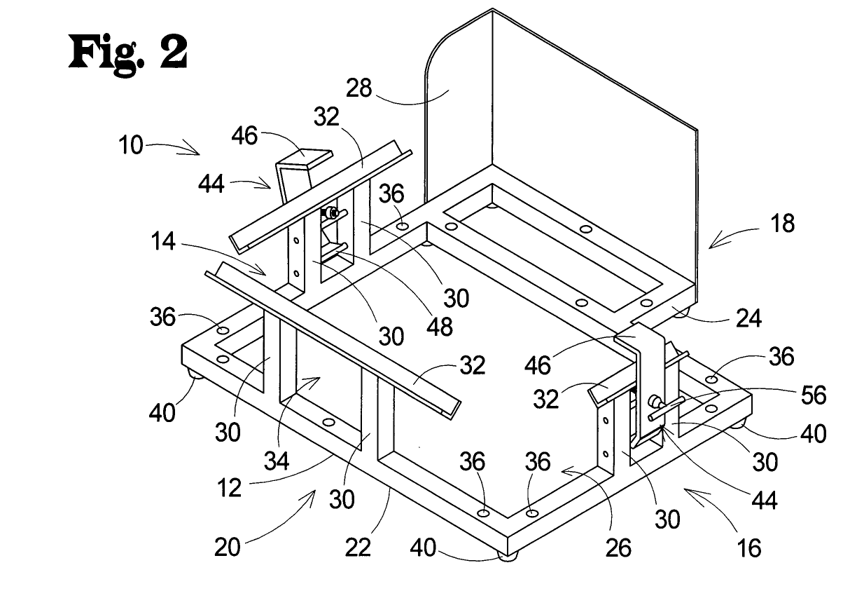

FIG. 2 depicts the embodiment of the transport apparatus for surface cutting equipment (10) as depicted in FIG. 1. For purposes of simplification references to the various sides will conform to the respective sides of the surface cutting device (1) that it is designed to receive. Thusly the front side (14) corresponds to the side of the surface cutting device (1) that it traditionally moves in while making a cut. The left side (18), rear side (16) and right side (20) are correspondingly relative to the front side's (14) orientation.

In the embodiment illustrated in FIG. 1 the base frame (12) consists of a series of square rigid members forming two rectangles but is not so limited. For example; the base frame (12) may be constructed from round members forming open or closed structures or may consist of a solid or broken plate of material. The base frame (12) may be divided into specific areas corresponding to the design of the surface cutting device (1). Such areas may be identified in relation to the surface cutting device (1) itself, such as the carriage frame (22) and the blade frame (24) both of which are illustrated in FIG. 2 as occupying the space directly under the base plate (2) and the blade (9) respectively. The carriage frame (22) and blade frame (24) sections of the base frame (12) illustrated in the figures form a closed loop which is referred to as a base loop (26). The base loop (26) may be utilized in conjunction with a tethered lock such as a pad lock and chain or a cable loop lock to attach the surface cutting device (1) to the transport apparatus for surface cutting equipment (10).

The blade shield (28) may be connected to the base frame (12) in a configuration as to isolate the diverter assembly (6) from contact with foreign objects. In the illustrated figures the blade shield (28) encloses the front side (14) and the left side (18) of the diverter assembly (6) but is not so limited. For example the blade shield (28) may additionally enclose the rear side (16) of the diverter assembly (6) or alternately only occupy one of the sides of the diverter assembly (6) or only a portion of one or more of the sides or the area corresponding to the diverter assembly (6). The blade shield (28) may consist of rigid plate but may alternately be formed by a lattice, cage or mesh of materials. The height of the blade shield (28) may be dictated by the design of the diverter assembly (6) of the surface cutting device (1) but may extend above or below the diverter assembly (6) depending on users requirements.

A post (30) may be used to support a cradle (32) which in turn may support the surface cutting device (1). The posts (30) depicted in the figures are constructed in the same manner as the base frame (12) and are grouped in pairs, each pair of posts (30) supporting a single cradle (32) but the invention is not so limited. For example a single post (30) may support a single large cradle (32) sufficient to support the surface cutting device (1). Alternately a series of single posts (30) may each support their own cradle (32). Furthermore a single cradle (32) may be supported by a plurality of posts (30). In the depicted embodiment the pair of posts (30) connected to the base frame (12) and connected by a single cradle (32) forms a closed loop, referenced here as a side loop (34) that may be employed in a similar manner as the base loop (26) when using a loop type locking device. In addition a side loop (34) may be used as a handle for carrying the transport apparatus for surface cutting equipment (10). It is also possible to utilize the pair of posts (30) to connect a securing device (44).

The cradle (32) may be designed to conform to the portion of the surface cutting device (1) to which it supports. The cradles (32) depicted in the figures form a trough as they are designed to support the edge of the base plate (2). Alternately the cradle (32) may assume any form in which any specific part of the surface cutting device (1) may nest or be supported.

The base frame (12) may include one or more anchor apertures (36) which may be used in combination with an anchoring device (38) to permanently or removably mount the transport apparatus for surface cutting equipment (10) to a transport vehicle or storage structure. The anchor aperture (36) is depicted as a hole passing through the base frame (12). The figures depict the hole passing from top to bottom but the invention is not so limited in that the anchor aperture (36) may pass through the base frame (12) in any orientation. An anchor device (38) may comprise any number of mounting or fastening devices as a well known in the industry. Such anchor devices (38) may include; screws, such as wood screws, metal screws or thumb screws, etcetera, bolts, such as lock bolts, lug bolts, headless bolts, etcetera, pins such as cotter pins, coupling pins, tension pins, etcetera, rivet, nub, nail, stud or hook.

The base frame (12) may include one or more feet (40) to provide enhanced grip against the ground or vehicle bed. A foot (40) may provide a cushion against impact or vibration as well as affording a nonskid material to prevent movement of the transport apparatus for surface cutting equipment (10). The foot (40) may be attached to the bottom of the base frame (12) or may occupy more than one of the surfaces of the base frame (12) so that it may provide the same advantages of impact and vibratory mitigation when the transport apparatus for surface cutting equipment (10) is placed against the wall of a transport vehicle.

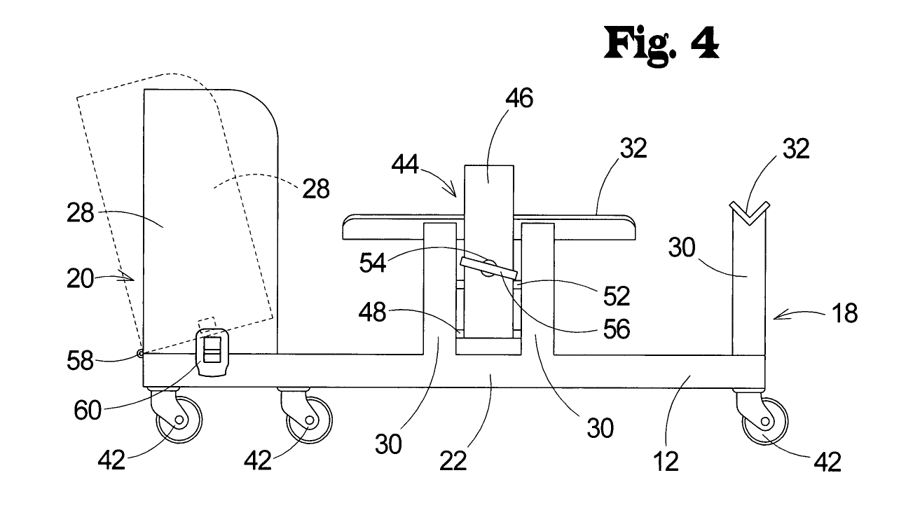

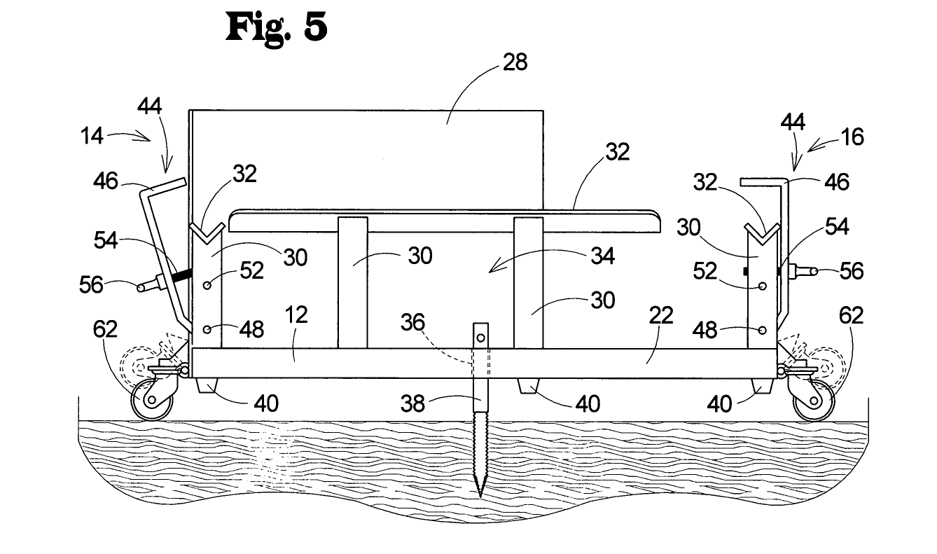

In FIG. 4 the transport apparatus for surface cutting equipment (10) is depicted with a set of wheels (42), specifically caster wheels (42). It is anticipated that wheels (42) may be added to the transport apparatus for surface cutting equipment (10) so that it may be more easily be moved from the transport vehicle to the work site. It order top provide the listed advantages the wheels (42) may include locking mechanisms to constrain movement while in transport mode. Alternately the wheels (42) may be removable while the transport apparatus for surface cutting equipment (10) is being transported or the use of retractable wheels (62) may be employed as depicted in FIG. 5. The wheels (42) depicted in FIGS. 4 and 5 are mounted to the bottom of the base frame (12) but the invention is not so limited. For example wheels (42) could be mounted on the side of the base frame (12) or the posts (30) or the cradles (32) or even the blade shield (28) by attaching an axle supporting a wheel (42) with a radius greater than the height to which the axle was mounted. The axle may span the distance between parts of the base frame (12), posts (30) cradle (32) or blade shield (28) or could be supported solely by only one of the parts.

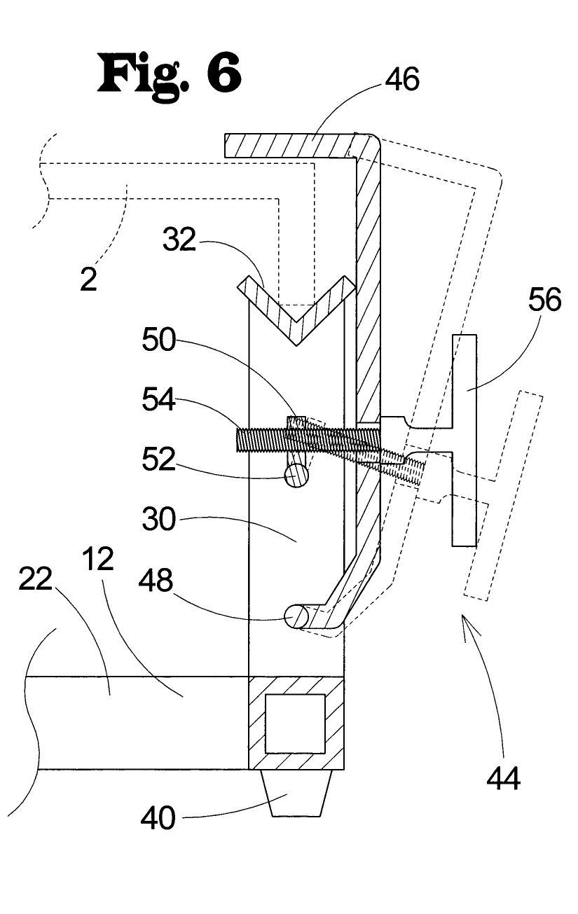

The attached figures depict this embodiment of the transport apparatus for surface cutting equipment (10) with a securing device (44) for fastening the surface cutting device (1) to the transport apparatus for surface cutting equipment (10). In the illustrated embodiment the securing device (44) consists of a catch (46) that acts to fix a portion of the base plate (2) against the cradle (32) and keep it in place. The embodiment is best depicted in FIG. 6. The catch (46) is hinged between two posts (30) by a catch hinge (48). The catch (46) includes a tension screw (54) that passes through the catch (46) and through the lock nut (50) which is mounted on a lock nut hinge (52) which is similar in design to the catch hinge (48). By rotating the tension screw (54) by the knob (56) the catch (46) can be moved from an open position wherein the base plate (2) is not secured to a closed position wherein the base plate (2) may be secured. It is anticipated that many other methods may be engaged for securing the surface cutting device (1) to the transport apparatus for surface cutting equipment (10) and the illustrated embodiment is only meant as one such example.

In FIG. 4 the blade shield (28) includes a shield hinge (58) so that the diverter assembly (6) may be accessed while the surface cutting device (1) is mounted to the transport apparatus for surface cutting equipment (10). FIG. 4 depicts the shield hinge (58) mounted to the base frame (12) on the right side (20) but the invention is not so limited. For example the shield hinge (58) may be mounted on any side of the base frame (12). The shield hinge (58) may form a break on the surface of the blade shield (28) at any point along the blade shield's (28) height or length. The shield hinge (58) may comprise only a portion of the blade shield (28) possibly forming an aperture in the blade shield (28). Securing the blade shield (28) in a closed position when the shield hinge (58) is utilized is the shield latch (60). In FIG. 4 the shield latch (60) is depicted as a simple tension latch as is employed in many tool boxes and storage containers. It is anticipated that many other latching devices could be employed in securing the hinged blade shield (28) in place.

It is to be understood that the above description is intended to be illustrative, and not restrictive. Many other embodiments will be apparent to those skilled in the art upon reviewing the above description. The scope of the invention should, therefore, be determined with reference to the appended claims, along with the full scope of equivalents to which such claims are entitled.

What is claimed is:

1. A transport apparatus for surface cutting equipment comprising:
a base frame,
a post connected to the base frame with sufficient length to elevate the wheels of the surface cutting device off the ground,
a cradle connected to the post fashioned to accept a portion of a surface cutting device,
A blade shield connected to the base frame able to isolate a portion of the diverter assembly or blade.

2. The transport apparatus for surface cutting equipment of claim 1 wherein the configuration elements selected from the group consisting of base frame, posts and or cradle forms a closed loop in which a tether or loop type locking device can secure the surface cutting device to the transport apparatus to the surface cutting device when the locking device is also threaded through an available aperture in the surface cutting device and through a closed loop in the structure of the transport apparatus for surface cutting equipment.

3. The transport apparatus for surface cutting equipment of claim 1 including feet mounted to the bottom of the base frame.

4. The transport apparatus for surface cutting equipment of claim 1 including wheels.

5. The transport apparatus for surface cutting equipment of claim 4 wherein the wheels are removable.

6. The transport apparatus for surface cutting equipment of claim 4 wherein the wheels are retractable.

7. The transport apparatus for surface cutting equipment of claim 1 wherein a first cradle and a second cradle are supported on posts of different lengths to support portions of the surface cutting device that are located at different elevations.

8. The transport apparatus for surface cutting equipment of claim 1 wherein the cradle supports the edge of the base plate of the surface cutting device.

9. The transport apparatus for surface cutting equipment of claim 1 including an anchor aperture for receiving an anchor device.

10. The transport apparatus for surface cutting equipment of claim 9 wherein the anchor device is selected from the group consisting of a screw, a bolt, a pin a rivet, a nub, a nail, a stud, a hook.

11. The transport apparatus for surface cutting equipment of claim 10 wherein the anchor device includes a locking means.

12. The transport apparatus for surface cutting equipment of claim 11, wherein the locking means comprises a cotter pin.

13. The transport apparatus for surface cutting equipment of claim 1 where the blade shield includes a means for accessing the diverter assembly.

14. The transport apparatus for surface cutting equipment of claim 13 wherein the blade shield includes a hinge so that the diverter assembly can be accessed when the blade shield is hinged from a first position into a second position.

15. The transport apparatus for surface cutting equipment of claim 14 including a shield latch for locking the blade shield in said first position.

16. The transport apparatus for surface cutting equipment of claim 1 including a securing device for securing the surface cutting device to the transport apparatus for surface cutting equipment.

17. The transport apparatus for surface cutting equipment of claim 16 wherein the securing device includes a catch which captures a portion of the surface cutting device between the catch and the cradle.

18. The transport apparatus for surface cutting equipment of claim 17 wherein the securing device includes a tension screw that regulates the position of the catch.

19. The transport apparatus for surface cutting equipment of claim 1 wherein the portion of the cradle that contacts the surface cutting device includes a cushioning material to prevent damage to the surface cutting device by the cradle.

20. A transport apparatus for an early entry saw comprising:
a base frame,
a post connected to the base frame with sufficient length to elevate the wheels of the early entry saw off the ground,
a cradle connected to the post fashioned to accept a portion of a early entry saw,
A blade shield connected to the base frame able to isolate a portion of the diverter assembly or blade.
